(19) United States
(12) Patent Application Publication
(10) Pub. No.: US 2007/0158540 A1
(43) Pub. Date: Jul. 12, 2007

(54) Liquid trap for collecting liquids in a vacuum device

(76) Inventor: Manfred Faubel, Rosdorf (DE)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 10/527,676

(22) PCT Filed: Sep. 12, 2003
(86) PCT No.: PCT/EP03/10164

§ 371 Date: Dec. 16, 2005

(30) Foreign Application Priority Data
Sep. 13, 2002 (DE) 102 42 622.8

(51) Int. Cl. H01J 49/00

(52) U.S. Cl. 250/281

(57) ABSTRACT

A liquid trap (10), in particular, for collecting liquids a vacuum device is described, with a trap container (11), which has an inner space (13) and an inflow element (13), through which liquid can enter from an outer space (20) of the liquid trap (10) into the inner space (12) of the trap container (11), whereby the inflow element (13) is formed by an inlet channel (15) in a wall (14) of the trap container (11) and the inlet channel (15) has an inner diameter (D) with D<2 mm and an inner length (L) with L<4 mm.

The invention relates to a liquid trap according to the preamble of claim 1, vacuum devices, which are equipped with such a liquid trap, and methods for collecting liquids or frozen particles under vacuum conditions.

It is known that with a series of applications in the vacuum chamber of a vacuum device, for purposes of measuring or technical methods, a continuous or drop-shaped jet of a liquid substance is introduced. For example, for mass spectrometry of sensitive molecules, a solution of the molecules in water is introduced into the vacuum chamber of the mass spectrometer and there, a laser-supported desorption of the solvent is performed, in order to then analyze alone the dissolved molecules via a mass spectrometer. Röntgen or UV sources represent further examples, in which under vacuum conditions through high-energy radiation (for example, laser radiation), a liquid target material is set into a plasma condition, in which material-specific Röntgen fluorescent radiation is emitted. (See, for example, EP 186,491, U.S. Pat. No. 5,459,771, L. Rymell et al in “Rev. Sci. Instrum,” Band 66, 1995, pages 4916-4920, WO 97/40650, U.S. Pat. Nos. 6,377,651, 6,324,255, L. Malmqvist et al in “Appl. Phys. Lett.”, Band 68, 1996, pages 2627-2629, DE 100 47 779).

A general problem with the introduction of a liquid into a vacuum exists in the volatility of the liquid or other reaction products. Typically, the liquids used have a vapor pressure of a few millibars with temperatures above the respective triple point. The vapor of the liquid can deteriorate the vacuum drastically or lead to bothersome deposits in the vacuum device. Specifically, the following three problems are resulting.

First, until now, for compensation of the production of problematic vapor, particular high-capacity high vacuum pumps must be used. With a small diameter of a liquid jet of 10 μm to 30 μm, for example, pumps with suction speeds with a magnitude of 1000 1·s⁻¹ are required.

Second, for collection of liquids, collection devices (or liquid traps) are necessary. A common liquid trap 10′ is shown schematically by way of example in FIG. 5 (see for example, U.S. Pat. Nos. 5,577,091, 5,459,771, S. Düsterer et al in “Spektrum der Wissenschaft”, September 2001, page 78). The liquid trap 10′ includes an additional trap container 11′ separated from the vacuum chamber with an inner space 12′, in which the liquid to be collected is fed in by means of an inflow element 13′. The inflow element 13′ comprises a funnel 13a′ and a capillary 13b′, which opens into the trap container 11′ with a specific length on a wall 14′.

Common liquid traps with a capillary- or a tube-shaped inflow element have numerous disadvantages. The capillary forms a flow barrier for the vapor of the collected liquid in the trap container. Nevertheless, a reverse flow of the vapor through the inflow element back into the vacuum chamber takes place. Thus, upon transition from the inflow element into the outer space, an ultrasonic expansion of the outflowing vapor occurs. Because of this counter flow, turbulence occurs, which disturbs the arriving liquid jet and prevents collection of further liquid. In addition, obstruction of the entering liquid in the inflow element takes place. Finally, the vacuum of the vacuum chamber is impaired by the reverse-flowing vapor. In order to address these disadvantages, it has been proposed until now to equip the liquid trap with a cooling device on the basis of liquid nitrogen, with which the collected liquid is frozen (see M. Faubel et al in “Z. Phys. D”, Band 10, 1988, page 269; H. Morgner et al in “J. Electron Spectroscopy Relates Phenomena”, Bd. 61, 1993, page 183; L. Malmqvist et al in “Appl. Phys. Lett.”, Band 68, 1996, page 2627-2629). An alterative is the connection of a further vacuum pump to the cooling trap (see S. Düsterer et al in “Appl. Phys. B”, Bd. 73, 2001, pages 693-698). Both solutions, however, have the disadvantage of an increased expense for apparatus. In addition, with this method, the gas load of the vacuum chamber by a vapor reverse flow from the trap is significantly reduced. However, destabilization of the entering liquid jet can take place by the occurring gas flow. The destabilization can be achieved merely by means of a cooling-related reduction of the vapor pressure. With volatile liquids, this leads unavoidably to ice formation in the trap and to blockage of the inflow element.

The advantages of liquid recycling, such as that demonstrated, for example, by H. Morgner et al (see above), are limited to specific liquids, such as, for example, formamide and other liquids with very low vapor pressure. An application with water or jets of liquefied inert gases is impossible with this technology.

The inflow element used until now, in addition, has the disadvantage of a higher mechanical sensitivity. With a small load, for example, with ventilation of the vacuum device, a disadjustment of the capillary occurs.

Third, the liquids in the vacuum chamber under high vacuum generally represent under-cooled liquids, which freeze easily upon contact with surfaces. The danger exists that the inflow element of the cooling trap is closed by frozen deposits. In order to address this problem, the inflow element is heated during the collection up to a few hundred degrees (see, for example, U.S. Pat. No. 5,577,091). Therefore, however, there is a disadvantage, in that by heating, new vapor is produced, which impairs the vacuum. In addition, temperature gradients exist, which can be detrimental for the vacuum device and the liquid probes.

The object of the invention is to provide an improved liquid trap for collecting liquids in a vacuum device, with which the disadvantages of common liquid traps are overcome. In particular, the liquid trap should have a simplified structure, should simplify the operation of the vacuum device, should avoid the described problems caused by reverse flowing vapor, and should be suited for collection of liquids with relatively high vapor pressure. The liquid trap, in particular, should be suited for collecting liquids with a vapor pressure of several hundred mbar, such as, for example, liquid inert gasses Ar, Kr, or Xe. A further object of the invention is to provide an improved method for collecting liquids in a vacuum device, with which the disadvantages of the common technology are overcome. Finally, it is also the object of the present invention to provide improved applications of the liquid trap.

These objects are solved by liquid traps, vacuum devices, and methods with the features according to patent claims 1, 12, and 16. Advantageous embodiments and applications of the invention are provided in the independent claims.

A basic idea of the invention is to provide a liquid trap, which has a trap container with an inner space and an inflow element, through which liquid or frozen particles can enter from an evacuated outer space of the liquid trap into the trap container and vapor can flow from the trap container into the outer space, wherein, contrary to common technology the inflow element is not provided by a positioned flow barrier, for example, in the form of a capillary, but is formed as an inflow channel in a wall of the trap container, which has predetermined geometric dimensions (in particular, diameter, length), which are optimized with reference to the interplay of the entering liquid with outflowing vapor, such that the outflowing (reverse flowing) vapor flow can be repressed effectively up to atmospheric pressure. The inlet channel forms an opening (aperture), on which, on one wall side the inner space and on the oppositely disposed wall side, the outer space directly adjoin.

According to the present invention, the inner diameter D and the inner length L of the inlet channel have the dimensions D<2 mm and L<4 mm, respectively. The collection of the liquid through the aperture in the wall of the trap container has a series of advantages, which relate to the design of the trap as well as to its function. First, the structure of the liquid trap is substantially simplified. The inflow element can be mounted with minimal dimensions on any desired position in the wall of the trap container. Second, the function of the trap is improved. The inventors have found that an aperture as an inflow element surprisingly far surpasses a channel-shaped inflow element in terms of flow technology. In the region of the opening of the wall of the trap container, an obstruction of entering liquid is avoided. The path of the liquid through the inflow element is shortened. The danger of deposits and blockage is avoided. In addition, the diameter of the opening can be reduced, which affects advantageously a reduction of the reverse flow. The load of the vacuum in the vacuum devices can be reduced.

The noted length (L), in particular, is smaller than or the same as a predetermined congestion length (L*), above which outflowing vapor in the inlet channel would form a counter pressure, which would prevent a contact-free entry of the liquid relative to the inlet channel. The diameter (cross sectional dimension), in particular, is smaller than or the same as a predetermined congestion diameter (D*), above which outflowing vapor would prevent entry of the liquid into the inlet channel. The inventors have found that by reducing the diameter of the inflow element, multiple advantages can be achieved simultaneously. First, the amount of the outflowing vapor is reduced. Second, the above-noted ultrasonic expansion of the outflowing vapor can be reduced or is eliminated. The liquid can enter without impediment. Finally, the hole in the trap container can be closed dynamically by the entering liquid. By means of an optimization of the properties of the liquid, which form a continuous jet or succession of drops, and of the diameter of the inlet channel, during the collection, the free space for a reverse flow is reduced.

According to a preferred embodiment of the invention, the inflow element of the liquid trap has a conical outer wall, which projects in a tapered manner from the wall of the trap container into an outer space, for example, a vacuum chamber. The conical shape has the particular advantage that a reflection of the gas atmosphere flowing onto the liquid trap is reduced, and therewith, the stability of the operation upon collection, in particular, of liquids with high vapor pressure (for example, inert gases), is improved. A further advantage exists in the increase of the stability of the inflow element by the conical structure.

It is particularly advantageous if the inflow element has an inclined outer wall. The outer wall forms an angle relative to the orientation of the inlet channel, which is designated also as the outer or incline angle. The incline angle generally is greater than 0° and less than 90°. Preferably, the incline angle lies in the range of 30° to 70°, in particular, from 45° to 70°.

The diameter (D) preferably has a value in the range of 1 μm to 1 mm, in particular, from 5 μm to 100 μm. Advantageously, for a plurality of liquids relevant in the practice, similar diameters of the inlet channel can be selected.

Flow-dynamic considerations of the inventors provide that advantages for a disruption-free collection of the liquid are provided when then length (L) is less than the double diameter (D) and greater than 1 μm.

According to further advantageous embodiments of the invention, the liquid trap is provided with a heating device, with which the inflow element can be tempered, a first adjustment device, with which the diameter of the inlet channel is adjustable, and/or a second adjustment device, with which the position of the liquid trap in the outer space is adjustable. The heating device can offer advantages at the beginning of the trapping operation, in the event the aperture of the inlet channel is oriented not exactly to the movement direction of the. entering liquid. With the heating device, a freezing of the liquids upon contact with the trap surface can be avoided. When little or no liquid is collected in the trap, a reverse flow does not occur, which prevents a contact of the liquid with the wall of the inlet channel. Freezing of the liquid on the wall is eliminated with the heating device. The heating device, however, can be dimensioned smaller than the common capillary heater and can be switched off after a specific start time. With the first adjustment device and an adjustable opening in the trap container, the trap can be adapted advantageously to liquids with different flow properties. The provision of the second adjustment device can be advantageous, in order to position optimally the liquid trap under concrete conditions in a vacuum device. The second adjustment device, depending on the concrete application, can be waived when adjustability of the liquid trap is not necessary and/or a liquid source in the vacuum device is equipped with its own adjustment device.

A further subject of the invention is a vacuum device (for example, a Röntgen or UV source, mass spectrometric analytical device, or a device for molecular distillation) with a vacuum chamber, a liquid source, with which the liquid can be supplied into the vacuum chamber, and the liquid trap of the present invention. The vacuum device has the advantage that fewer requirements can be placed on the vacuum pumps than with common vacuum devices in which liquids appear.

The vacuum device can have a modular structure, in which the liquid trap can be inserted advantageously as a module into a wall of the vacuum chamber and is exchangeable. A part of the wall of the vacuum chamber can form the wall of the trap container, in particular, and be equipped with the inflow element.

According to a preferred embodiment of the invention, the vacuum device is equipped with an adjustment device, with which the liquid source and the liquid trap can be adjusted relative to one another. The adjustment device includes, for example, an optical adjustment device with a laser and a diffused light detector.

A subject of the present invention also is a method for collecting (or separating, removing) a liquid in a vacuum device using the liquid trap of the present invention. Preferably, drops, jets, or frozen particles with diameters in the range of 1 μm to 100 μm and vapor pressures in the range of 10 mbar to 1000 mbar are collected. With regard to the method, the invention has the particular advantage that for collection, no particular vacuum or cooling devices must be actuated or controlled. The liquid trap can be operated at ambient temperature without cooling media and without an additional cooling device.

The invention has the following further advantages. Different types of liquids (for example, water, organic solvents, inorganic liquids) not only with a low vapor pressure, rather also with an increased vapor pressure, for example, in the range of 10 to 100 mbar or more, can be collected without cooling media. The collection is possible even with argon or xenon, which are liquids that are difficult to manipulate in vacuum devices because of high vapor pressure. In addition, the recovery of the liquid (recycling) is substantially simplified.

Further details and advantages of the invention are described next with reference to the attached figures. In the drawings:

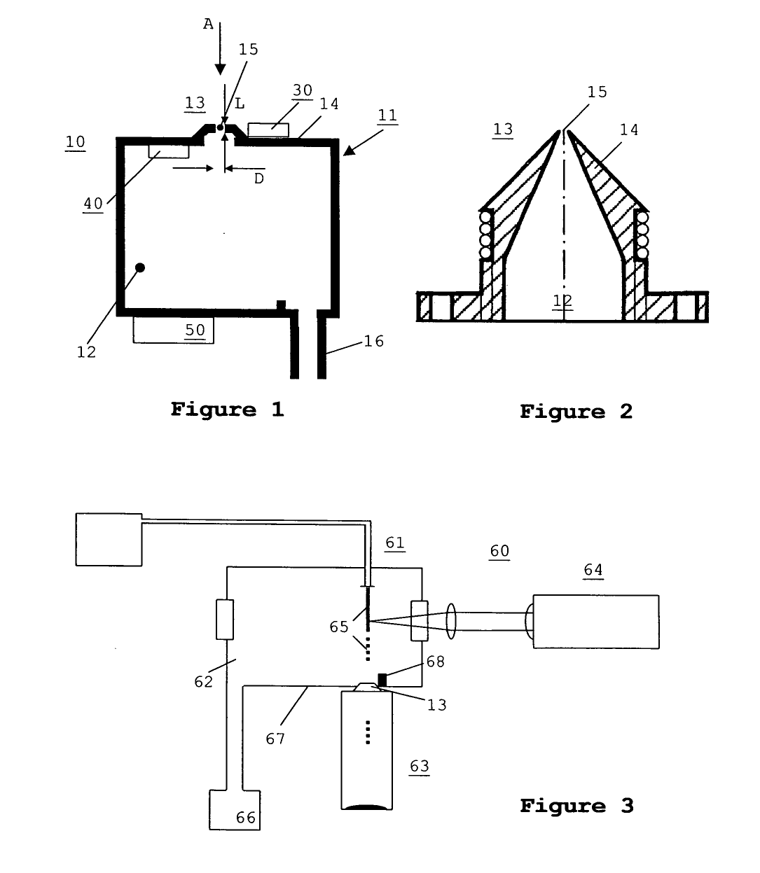

FIGS. 1 and 2 show schematic sectional views of different embodiments of the liquid trap of the present invention;

FIG. 3 shows a schematic sectional view of an embodiment of a vacuum device according to the present invention;

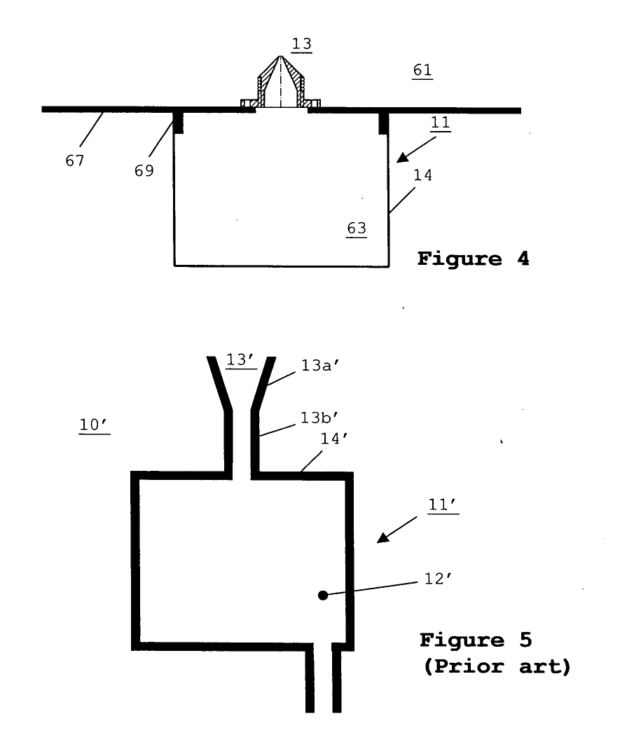

FIG. 4 shows a partial view of a vacuum device of the present invention; and

FIG. 5 shows a schematic view of a common liquid trap.

The invention will be described next with reference to embodiments and flow-theoretical model considerations. It should be noted that the implementation of the present invention is not limited to the dimensions of the liquid trap according to the theoretical considerations or to the embodiments shown. In addition, it is possible for the practitioner to adapt the design of a liquid trap, for example, by simple trials, to the respective application, whereby, in particular, the selection, combination, or geometric properties of the liquid and/or the geometric dimensions of the inlet channel can be varied. In addition, it should be noted that the liquid trap is suited also for collection of solid particles, for example, ice crystals. The description of the embodiments applies for the collection of frozen particles accordingly.

A first embodiment of a liquid trap 10 of the present invention is schematically illustrated in FIG. 1. The liquid trap 10 includes a trap container 11 with an inner space 12, which is delimited against the surrounding environment (outer space) by a wall 14. The surrounding environment adjoins an evacuated space, for example, the vacuum chamber of a vacuum device (see below) at least on one side of the trap container. The trap container 11 has a shape and size, which are selected according to the application, for example, the shape of a cylindrical beaker or a bottle with an inner space volume, for example, of 50 to 1000 cm³. The wall 14 comprises, for example, steel or another material that is inert for the respective use, with a thickness of 1 to 10 mm, for example. On the lower side of the trap container, a drain 16 can be provided, through which liquid can flow into a connected collection system, or if necessary, after achieving a minimum on the container floor and exceeding a barrier in front of the drain 16. The drain 16, however, does not represent a required feature of the present invention.

The trap container can be equipped with a tempering device (not shown), in particular, in order to adjust the pressure of the vapor in the trap. The tempering device can include a cooling device or a heating device. The heating device, in particular, can be provided with the collection of frozen liquid particles, in order to melt the liquid. Thus, an outgrowing of liquid crystals, for example, icicles, from the trap into the vacuum chamber can be avoided. The provision of the tempering device, however, is not necessarily required for a stabile separation operation, in particular, with liquids such as water or ethanol. The tempering device preferably is provided with collection of liquefied gases.

In addition, the liquid trap according to a modified embodiment can be connected with a recycling device, which permits a continual recovery of the collected liquid during the operation of the vacuum device. With common traps, a continual recovery is not possible, since this is connected with a ventilation or a complete switching off of the vacuum device. This would lead to many hours of down time. This disadvantage can be overcome with the liquid trap of the present invention, since, even the formation of atmospheric pressure during collection in the trap container 11 represents no limitation for the collection of the liquid or the quality of the vacuum in the adjacent vacuum chamber.

The inflow element 13 provided with the present invention includes a through-going opening (hole), which is formed on the top side of the trap container 11 in the wall 14. By the opening, an inlet channel 15 is formed. The inlet channel 15 extends with a specific diameter D over a predetermined length L and is defined on both sides of the wall directly by the inner space 11 and the outer space. The wall 14 can be formed on the top side of the trap container 11 as one piece with the remaining wall or also as an independent wall element, which is connected with the remaining wall. The wall element, for example, can have a conical structure (see FIG. 2).

The length of the inlet channel 15 is equal to the thickness of the wall adjacent the hole, in particular, the front side of the adjacent wall. The wall can be tapered towards the inlet channel 15 (see FIG. 2).

The components 30, 40, and 50 are provided facultatively individually or in combination. The inflow element 13 can be tempered with the heating device 30. For example, a resistance heating for at least temporary adjustment of a temperature above the vapor temperature of the liquid to be trapped under vacuum conditions is provided. In addition, when the wall has a lamella structure, the cross section of the inlet channel 15 can be changed with the first adjustment device 40. When the liquid trap is to be positioned in a vacuum chamber, then this can take place with the second adjustment device 40, 50. The first and second adjustment devices 40, 50 can be formed, for example, by piezoelectric drives.

The collection of a liquid (droplets or a jet) with the liquid trap 10, which is arranged in a vacuum device with a vacuum chamber, includes the following steps. The liquid generally forms a jet or succession of droplets with a radius in the range of 1 μm to 0.5 mm. Next, it can be provided that the liquid trap 10 is positioned, if necessary, relative to the path of movement of the liquid in the vacuum chamber. The path of movement, for example, can be a vertical fall length (see arrow A), a ballistic path, or a horizontally oriented path. The positioning takes place, preferably, using an adjustment device (see FIG. 3) and can take place with a bit of heating of the inlet channel of the liquid trap. The latter prevents freezing of the liquid upon contact with the surfaces of the liquid trap. Subsequently, the corresponding operation of the vacuum device begins. The liquid enters through the inlet channel 15 from the vacuum chamber into the trap container 11. In the time elapsed, vapor of the liquid collects in the trap container 11. The vapor flowing back into the outer space because of the pressure drop meets the liquid in the inlet channel. The inlet channel 15, according to the present invention, however, can be measured, such that the vapor does not repel the liquid or press on the wall.

The length L and the diameter D preferably are selected according to the following principles. The inlet channel 15 is permeated from outside to the inside by the liquid, which is to be collected, and from inside to the outside by the reverse flow of the vapor of the collected liquid.

The liquid is subjected in the inlet channel to a friction relative to the reverse flow and is slowed down by it. When the length of the inlet channel 15 exceeds a specific length (the so-called congestion length), a slowing down to zero is theoretically possible. The congestion length can be estimated with the following concept.

The slowing force F, which experiences a sphere (for example, a liquid drop) with a radius R in an opposing laminar flow, is provided from the Newton formula (1):
F=0.5·c·ρ_{gas}·(Π·R²)·v_{gas}² (1)

For the case of a sphere, which moves in a continuous flow, the constant c assumes the value c˜2. The factor ρ_{gas} is the gas density, which can be estimated from the vapor pressure within the trap. The gas velocity v_{gas} can be estimated from the energy and the molecular mass of the vapor.

The congestion length L* is provided according to equation (2) from the velocity of the falling liquid v_{liq} and the negative acceleration by the force F (ρ_{liq} is the density of the liquid):
L*=v_{liq}²·(4/3)·c⁻¹·ρ_{gas}⁻¹·v_{gas}⁻²·ρ_{liq}·R (2)

Accordingly, the congestion length L* can be determined from the properties of the liquid to be collected and the conditions process. The congestion length L* lies, for example, for typical micro-liquids (in particular, R≈5 . . . 50 μm), in the range of 20 μm to 2 mm with gas pressures between 1 kPa and 100 kPa. According to formula (2), the congestion length depends directly on the drop size R. The accumulation of the drops by means of a gas reverse flow from the liquid trap represents a problem in the vacuum assembly, in particular, with small radii of the drops or the liquid jet with R<50 μm. This is avoided by the dimensioning of the inlet channel according to the present invention.

The vapor flowing back into the vacuum chamber experiences an expansion upon leaving the inlet channel 15, which can be described as a radial, isotropic expansion on the axis of symmetry of the inlet channel 15. The smaller the density of the vapor is upon leaving the inlet channel 15, the smaller is the kinetic energy converted into turbulence with the expansion. The density of the vapor is reduced with the square of the diameter of the inlet channel.

When the diameter of the inlet channel 15 exceeds a specific value (the so-called congestion diameter D*), it is difficult to maintain the vacuum on the one hand. On the other hand, disturbance of the entrance of the liquid is possible. The congestion diameter can be estimated by comparison of the kinetic energy of the arriving liquid and the energy converted upon the expansion.

The inventor has estimated the congestion diameter according to the equation (3):
D*=2·v_{liq}²·ρ_{liq}·R·ρ_{gas}⁻¹·v_{gas}² (3)

Again, it is shown that the congestion diameter D* can be determined from the process conditions, for example, the radius of the liquid drops or the liquid jet. The congestion diameter D* lies, for example, in the range of 1 μm to 1 mm, preferably, in the range of 5 μm to 100 μm. From equations (2) and (3), the correlation D* −5.3 L* is provided. The congestion diameter D*, in particular, can be less than the 20-times the radius of the falling liquid drops or of a jet. The inventors have found that the congestion length L* preferably is smaller than the doubled congestion diameter D*.

Beginning from D* according to equation (3), which represents the theoretical congestion diameter, the real diameter of the inlet channel preferably is selected to be greater than the radius R of the liquid jet (or the drops) and less than the congestion diameter (R<D<D*) and the length L of the inlet channel is greater than 1 μm and less than the doubled diameter (1 μm<L<2D) These conditions preferably are selected with D*<1 mm and 1 μm<R<500 μm.

It was shown, for example, that with collection of ethanol drops with a velocity of 100 m/s and a diameter of 10 μm and D=100 μm, the high vacuum in the vacuum chamber can be completely maintained. For xenon or water vapor, smaller channel dimensions in the range of 10 μm were noted to be advantageous.

A modular useable inflow element 13 is shown in FIG. 2 by way of example. The wall 14 is cone-shaped with a thickness tapering towards the inlet channel 15. Such a geometry with an outer angle of less than 70°, preferably, however, greater than 45°, supports the stability of the trap operation, since wall reflections from the gas atmosphere are prevented, which encompass the inflowing liquid. The inlet channel 15 has a diameter of approximately 100 μm and a length of approximately 100 μm. The diameter of the inner space 12 following first beneath the inlet channel 15 amounts to 10 mm, for example. The inner angle of the inflow element 13 is selected, such that the length L of the inlet channel 15 is less than the doubled diameter of the inlet channel 13.

Alternatively, the upper wall 14 of the liquid trap 10 can be formed by a thin plate or film with the inflow element 13. The plate or film has the same thickness as the desired length of the inlet channel.

The inflow element according to FIG. 2 advantageously can be made as a component that is separable from the liquid trap. The inflow element 13, for example, can be screwed onto a liquid trap. Thus, a given liquid trap can be equipped according to the liquid used with an adapted, exchangeable inflow element.

The combination of the liquid trap with a vacuum deice is illustrated schematically in FIG. 3 as an example of a plasma-based Röntgen source 60.

The Röntgen source 60 includes a target or liquid source 61, which is connected with a vacuum chamber 62, and as a collection device a liquid trap 63 of the present invention. The liquid trap 63 is completely or (as shown) only partially arranged in the vacuum chamber 62, so that at least the inflow element 13 projects into the vacuum chamber. The reference numeral 64 relates to an irradiation device. The liquid source 61 includes a reservoir for the target material, a supply line and a nozzle (or, a droplet gun). With an actuating device (not shown), which, for example, includes a pump or a piezoelectric supply device, liquid target material is supplied to the nozzle or droplet gun, and from this, is delivered in the form of a liquid jet or in the form of drops 65 and injected into the vacuum chamber 62.

The irradiation device 64 includes a radiation source (for example, a laser or another source of high-energy radiation, such as, for example, a source of Röntgen radiation or particle radiation) and a radiation optic, with which the radiation from the radiation source can be focused onto the target material 65. Alternatively, an ion or electron source can be provided in the chamber 62.

The vacuum chamber 62 includes a recipient with a chamber wall 67, which has at least one first window, through which the target material 65 can be radiated, and at least one second window, through which the generated Röntgen radiation exits. The second window, which is provided optionally, is made from a window material that is transparent for soft Röntgen radiation, for example, from beryllium, in order to release the Röntgen radiation from the vacuum chamber 62 for a specific use. The vacuum chamber 62, furthermore, is connected with a vacuum pump 66, with which a vacuum is produced in the chamber 62. This vacuum preferably lies beneath 10⁻⁵ mbar. If the second window is provided, an evacuatable processing chamber can be connected, which is connected with a further vacuum device (not shown). In the processing chamber, the Röntgen radiation for material processing can map onto an object. For example, a Röntgen lithography device is provided, with which the surface of a semi-conductor substrate is irradiated.

For generation of Röntgen radiation, a jet or drops of the target material 65 are produced with the liquid source 61. The diameter of the jet or the drops amounts to 3 μm to 0.1 mm, for example. The distance, which is covered by the target material 65 in the vacuum, typically lies in the range of mm to cm, for example, 1 mm to 10 cm, in particular 2 mm to 1 cm. For example, a series of drops of 10² to 10⁵ drops per second is generated. The drops 65 are irradiated with the radiation device in a known manner. The irradiation takes place in a focused manner with such an intensity that the target material is carried over into a plasma state, in which the emission of softer Röntgen radiation takes place.

The nozzle of the liquid source 61 and/or the trap 63 are preferably arranged to be adjustable, in order to optimize the opposite orientation. With the shown embodiment, the trap is inserted in the wall 67 of the recipient (see FIG. 4). Alternatively, the trap can be arranged in the recipient.

For opposite orientation of the liquid source 61 and the trap 63, an adjustment device 68 can be provided. The adjustment device 68 is based, for example, on a diffused light measurement, in which a laser beam is directed from the nozzle onto the inflow element 13 and the diffused light is detected on the inflow element 13. With incidence of light through the inlet channel, the diffused light is less than with impinging on an edge of the inflow element 13. Alternatively, the adjustment device 68 can be based on a mechanical-geometric measuring principle.

FIG. 4 shows a part of a vacuum device, in which the liquid trap is inserted as a module in a wall 67 of the vacuum chamber 61. With this embodiment of the invention, the wall of the liquid trap 63 is formed through the wall 14 of the liquid container 11, part of the recipient wall 67, and the inflow element 13. The inflow element 13, for example, is structured according to FIG. 2. The liquid container 11 is connected via a screw connection 68 in a vacuum-sealed manner with the recipient wall 67. Alternatively, the liquid container 11 can form a bottle with the inflow element 13, which is fixable in a vacuum-sealed manner in a corresponding mounting in the recipient wall.

The structure according to FIG. 4 has the particular advantage that the liquid container 11 can be exchanged also under vacuum conditions. With a temporary removal of the liquid container 11, because of the minimal diameter of the inlet channel, the vacuum in the vacuum chamber 61 itself is hardly afflected with atmospheric pressure in the liquid container 11. The liquid trap of the present invention makes possible advantageously a continual recovery of the liquid from the vacuum chamber. With common systems, for example, cryo-traps, the liquid cannot be recovered without an interruption of the vacuum operation. Down-times of many hours, such as that which occurs with common vacuum assemblies, can be avoided with the liquid trap of the present invention.

1. A liquid trap for collecting liquids or frozen particles in a vacuum device, comprising a trap container, which has an inner space and a inflow element, through which liquid can enter from an outer space of the trap container into the inner space of the trap container, wherein the inflow element is formed by an inlet channel in a wall of the trap container, and the inflow channel has an inner diameter (D) with D<2 mm and an inner length (L) with L<4 mm.

2. The liquid trap according to claim 1, in which the inlet element has a conically shaped outer wall, which projects in a tapered manner from the wall into the outer space.

3. The liquid trap according to claim 2, in which the outer wall forms an angle of less than 70° relative to the wall of the trap container.

4. The liquid trap according to claim 2, in which the outer wall forms an angle greater than 45° relative to the wall of the trap container.

5. The liquid trap according to claim 1, in which the diameter (D) is selected to be in the range of 1 μm to 1 mm.

6. The liquid trap according to claim 1, in which the diameter (D) is selected to be in the range of 5 μm to 100 μm.

7. The liquid trap according to claim 1, in which the length (L) of the inlet channel is less than two times the diameter (D).

8. The liquid trap according to claim 1, in which a heating device is provided, with which the temperature of the inflow element is temperable.

9. The liquid trap according to claim 1, in which a first adjusting device is provided, with which the diameter (D) of the inlet channel can be adjusted.

10. The liquid trap according to claim 1, in which a second adjustment device is provided, with which the position of the liquid trap in the outer space is adjustable.

11. The liquid trap according to claim 1, in which the inflow element is an exchangeable component.

12. A vacuum device comprising:
a vacuum chamber,
a liquid source, with which liquid can be supplied into the vacuum chamber, and
a liquid trap according to claim 1.

13. The vacuum device according to claim 12, in which the liquid trap can be set as a module in a wall of the vacuum chamber.

14. The vacuum device according to claim 12, which includes a plasma Röntgen source, a mass spectrometric analytical device, or a device for molecular distillation.

15. The vacuum device according to claim 12, which has an adjustment device, with which the liquid source and the liquid trap can be aligned relative to one another.

16. A method for collecting a liquid in drop-, jet-, or particle form with a predetermined radius (R) in a vacuum device with a vacuum chamber and a liquid trap, which has a trap container with an inner space and an inflow element, through which the liquid enters from the vacuum chamber into the inner space of the trap container and vapor of the liquid flows from the trap container into the outer space, comprising the steps of:
collecting a liquid with a radius (R) in the range of 1 μm to 100 μm and a vapor pressures in the range of 1 kPa to 100 kPa are collected, and
moving the liquid through an inlet channel, which is formed by the inflow element and having an inner diameter (D) with D<20R and an inner length (L) with L<2D.

17. The method according to claim 16, in which the flow of a gas atmosphere, which surrounds the liquid before collection, is reversed upon entry of the liquid into the inlet channel by a conical outer shape of the inflow element.

18. The method according to claim 16, in which the inflow element is heated at least at the beginning of the collection of the liquid.

19. The method according to claim 16, in which the liquid is collected in the liquid trap at ambient temperature.

20. The method according to claim 16, in which the liquid is collected after an irradiation for plasma-based production of Röntgen radiation or after separation from a substance to analyze in a mass-spectrometry analytical device.
